(19) United States
(12) Patent Application Publication
(10) Pub. No.: US 2010/0090966 A1
(43) Pub. Date: Apr. 15, 2010

(54) Capacitive Sensor Gloves

(75) Inventor: Pedro Gregorio, Verdun (CA)

Correspondence Address: WOMBLE CARLYLE SANDRIDGE & RICE, PLLC, ATTN: PATENT DOCKETING, P.O. BOX 7037, ATLANTA, GA, 30357-0037, US

(73) Assignee: IMMERSION CORPORATION, San Jose, CA (US)

(21) Appl. No.: 12/250,815

(22) Filed: Oct. 14, 2008

(51) Int. Cl. G06F 3/033; A41D 19/00

(52) U.S. Cl. 345/173; 2/167; 345/156

(57) ABSTRACT

A glove usable to activate a capacitive touch screen comprises a body configured to cover the palm and back of the hand and a plurality of finger sheaths configured to cover the fingers and thumb. An electrically conductive material is disposed preferably at the tip of at least one of the finger sheaths. The conductive material may be a thin sheet of conductive material, a disc of conductive material, or a fibrous conducting material woven into the fabric of the finger sheath. When the tip of the finger sheath is brought toward contact with a capacitive touch screen, the electrically conducting material effects the touch screen in a manner similar to the tip of a bear fingertip to cause the touch screen to recognize the gloved touch.

### TECHNICAL FIELD

This disclosure relates generally to touch screens and more particularly to the use of capacitive touch screens on devices such as cell phones and media players while wearing gloves.

### BACKGROUND

New generation consumer devices increasingly rely on touch screen inputs such as virtual buttons and sliders displayed on a screen as an alternative to physical inputs. For example the Apple iPhone® is operated almost exclusively by manipulating virtual buttons, sliders, scrollers, and the like on a screen with the fingers. Capacitive touch screen technology is largely displacing resistive touch screens due to industrial design, durability, and performance considerations. Generally, capacitive touch screens require “bare-handed” contact to sense a touch because the touch pad senses the fleshy fingertip, which, due the conductivity of the flesh, perturbs the field of the screen. This gives rise to a problem when a user wears cold weather or protective gloves. Most devices using capacitive touch screens cannot be used while wearing gloves because the material of the glove is an electrical insulator that insulates the fingers and prevents the capacitive screen from detecting the conductivity of the fingertips through the gloves. The thickness of the glove material also limits the closeness of the finger to the screen and certainly prevents actual touching. One solution has been to provide a glove with the tip of the index finger sheath cut out so that a wearer's bear fingertip protrudes slightly from the end of the sheath. While this does allow the bear fingertip to be used with a capacitive touch screen, it is far from ideal because the fingertip is exposed to the elements and is not protected or kept warm. The opening in the glove also allows air circulation and moisture penetration, which often defeats the very purpose of wearing gloves. For protective gloves, such as electrician's gloves, breaches of the glove are simply unacceptable. A need exists for a glove that retains all of its insulating and protective attributes and while allowing a wearer to operate the capacitive touch screen of a consumer device. It is to the provision of such a glove that the present disclosure is primarily directed.

### SUMMARY

Briefly described, the present invention, in a preferred embodiment thereof, comprises a glove that allows a wearer to interact with the capacitive touch screen of a device without removing the glove or exposing the wearer's fingers. The glove comprises a traditional glove body configured to cover the palm and back of the hand and finger sheaths that cover the fingers. At least one of the finger sheaths, for example the index finger sheath, is provided at least at its tip portion with an electrically conductive material beneath the outer layer of the glove. When a capacitive touch screen is touched with the end of the finger sheath bearing the conductive material, the conductive material perturbs the field of the screen just as does the conductive skin of a bear finger and thus emulates a touch with a bear finger. As a result, the virtual buttons and other elements of the screen can be activated while wearing the glove of the present disclosure without any breaches or openings being formed in the glove.

These and other objects, features, and advantages of the glove of this disclosure will be better understood upon review of the detailed description set forth below when taken in conjunction with the accompanying drawing figures, which are briefly described as follows.

### BRIEF DESCRIPTION OF THE DRAWINGS

FIG. 1 is a perspective view of a capacitive sensor glove that embodies aspects of the present disclosure in one preferred form.

FIG. 2 is a close-up partially cut away view of the tip of one of the finger sheaths of the glove of FIG. 1 illustrating one embodiment of a conductive material at the tip of a finger sheath.

FIG. 3 is a close-up partially cut away view of the tip of one of the finger sheaths of the glove of FIG. 1 illustrating another embodiment of a conductive material.

FIG. 4 is a close-up view of the tip of one of the finger sheaths of the glove of FIG. 1 illustrating another embodiment of a conductive material.

FIG. 5 is a close-up partially cut away view of the tip of one of the finger sheaths of the glove of FIG. 1 illustrating another embodiment of a conductive material.

### DETAILED DESCRIPTION

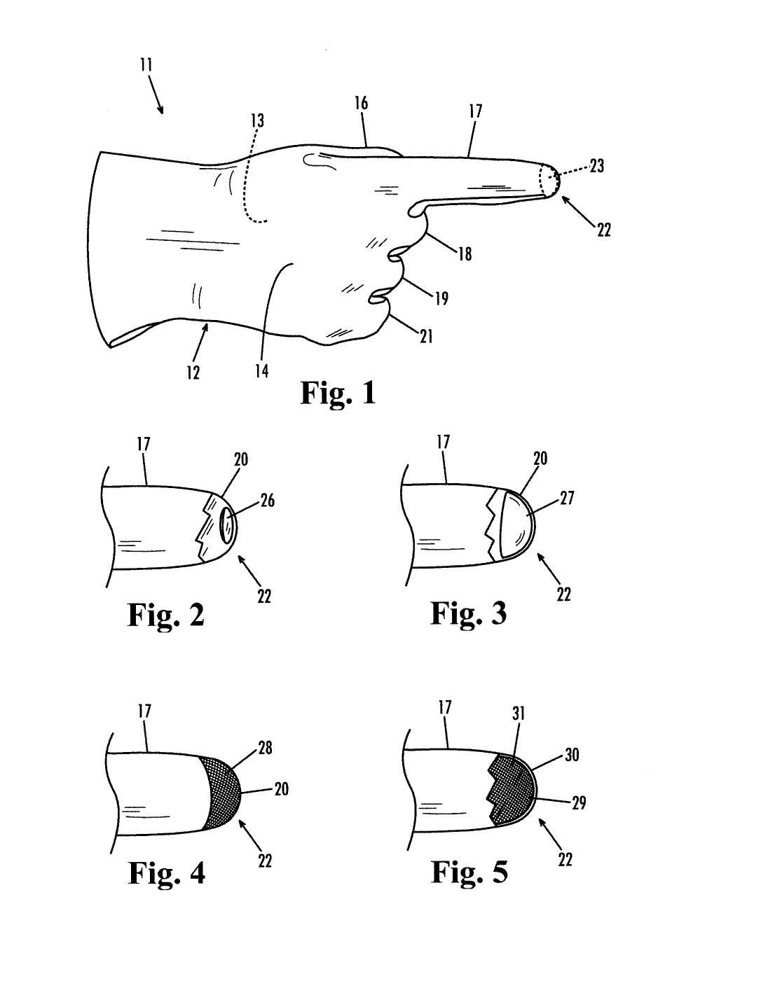

Referring now in more detail to the drawing figures, wherein like reference numerals identify like parts throughout the several views, FIG. 1 illustrates a capacitive sensor glove that embodies aspects of the invention in one preferred form. While a generic glove has been illustrated in FIG. 1, it should be appreciated that the invention is applicable to virtually any type of glove, from light fabric gloves, to heavy winter gloves, to work gloves, and even to specialty gloves such as surgical or protective electrician's rubber gloves. In FIG. 1, a glove 11 has a body 12 configured with a palm portion 13 (indicated with phantom lead line) configured to cover the palm of a wearer's hand and a back portion 14 configured to cover the back of the hand. A plurality of finger sheaths extend from the body of the glove and are configured to cover the fingers and thumb of a wearer. More specifically, a thumb sheath 16 covers the thumb, an index finger sheath 17 covers the index finger, and sheaths 18, 19, and 21 cover the remaining fingers of the wearer's hand. The finger sheaths each have a tip covering the tip of the wearer's fingers, the tip of index finger sheath 17 being indicated by reference numeral 22.

An electrically conductive material 23 is disposed at least at the tip 22 of at least one of the finger sheaths. In FIG. 1, the electrically conductive material 23 is disposed at the tip 22 of the index finger sheath 17. It should be understood, however, that such material may be disposed at the tips of more than one or all of the finger sheaths and thumb sheath if desired. For example, the index finger and thumb sheaths may be provided with electrically conductive material according to the disclosure. Further, the electrically conductive material may be disposed in one or more finger sheaths at locations other than just the tip of the sheaths such as, for example, at the knuckles or, indeed, in the entire sheath. In fact, in some embodiments, the entire glove may be rendered electrically conductive if desired.

The electrically conductive material may take a variety of forms and be composed of a variety of materials depending upon application specific requirements and parameters. For instance, the electrically conductive material may take the form of a small disc embedded in the tip of a finger sheath beneath the outer layer of glove material with the disc being made of a conductive metal such as copper or brass. The material may, alternatively, be a conductive fiber material such as fibrous copper or another metal or a more exotic fibrous material such as nano-coated silver fibers disposed in or woven into the material of the sheath. In such a case, the fibrous conductive material may be woven into the material of the outer layer of the finger sheath, or, alternatively, may be woven into an inner layer of material beneath the outer layer of the finger sheath. The electrically conductive material may also be a conductive semiconductor material, a carbon impregnated semiconductor material, aluminized Mylar, graphite, or conductive carbon fibers. In fact, the invention encompasses and includes any material, now know or hereinafter discovered, that exhibits sufficient and appropriate electrical conductivity to activate a capacitive touch screen. The term “electrically conductive material” as used herein encompasses all of the forgoing.

FIG. 2 illustrates in more detail one possible embodiment of a capacitive sensor glove according to the disclosure. The tip 22 of the index finger sheath 17 has an outer layer of material 23. A small disc or shim 26 made of an electrically conductive material is embedded in the tip 22 of the finger sheath just beneath the outer layer of material, perhaps between an inner layer of material and the outer layer or perhaps secured with appropriate adhesive or otherwise fastened to the inside of the outer layer of material. When the tip of the glove is brought toward engagement with a capacitive touch screen, the disc of conductive material emulates the tip of a bear finger and activates, i.e. the touch is sensed by, the capacitive touch screen.

FIG. 3 illustrates another embodiment wherein a layer of thin electrically conducting material is embedded in the tip 22 of finger sheath 17. In this case, the layer of conductive material may be shaped or formed to conform to the shape of the tip 22 and may be thin enough to flex with the material of the glove. A thin sheet of aluminized Mylar or a thin screen of woven conductive fibers, or a molded or shaped metal sheet material, for example, might be used for such an embodiment.

FIG. 4 illustrates an embodiment wherein the electrically conductive material is woven into the material of the finger sheath itself, here into the outer layer of material from which the finger sheath is constructed. In such an embodiment, the electrically conductive material may take the form of flexible, conductive, and weavable fibers such as graphite or conductive carbon fibers, nano-coated silver fibers, thin metal fibers, or any fiber that is sufficiently conductive and sufficiently ductile to be woven into the material of the glove.

FIG. 5 illustrates an embodiment that represents a modification of that shown in FIG. 4. Here, the finger sheath 17 has an outer layer of material 30 and an inner layer of material 29 beneath the outer layer. Other layers may be included between the inner and outer layers or beneath the inner layer as desired. Here, fibers or strands of electrically conductive material are woven into the material of the inner layer of material beneath the outer layer of material. This embodiment may be desirable in, for example, leather gloves where the outer layer of leather is not susceptible to being woven with conductive strands.

It will thus be seen that a conventional glove may be modified according to the invention with an electrically conductive layer applied at the fingertip of the index finger and/or the thumb or, in fact, any or all fingers if desired. The layer may be a thin sheet of electrically conducting material or a conductive plastic material or otherwise. In one embodiment, the layer of electrically conductive material is applied close to the outer surface of the glove with any insulating or protective layers of the glove preferably being beneath the electrically conductive material. The layer of electrically conducting material, then, simulates the capacitive response of an unshielded finger when interacting with a capacitive touch screen interface.

### EXAMPLE

The invention was prototyped by embedding at the tip of a glove finger a small disc made from a thin sheet of brass shim stock that was less that 5 mils thick. The disc was placed at the tip of the index finger sheath of a standard glove and covered with insulating tape to simulate an outer later of insulating material. The modified finger tip was then brought into contact with the click wheel of an iPod Nano® device. The prototype finger tip properly activated the click wheel of the device.

The invention has been described herein in terms of preferred embodiments and methodologies considered to be the best mode of carrying out the invention. However, various modifications and variations of the illustrated embodiments might be made by skilled artisans with such representing equivalent substitutes. For instance, while the invention has been illustrated within the context of a glove worn on the hands, it also might be implemented with normally non-conducting devices other than gloves. For example, the invention contemplates embedding an electrically conductive material in the plastic cap of a pen or pencil so that the pen or pencil might be used to interact with a capacitive touch screen. These and other additions, deletions, and modifications might well be made by those of skill in the art without departing from the spirit and scope of the invention, which is defined not by the illustrated embodiments but by the claims hereof.

What is claimed is:

1. A glove comprising:
a body configured to cover the palm and back of the hand;
a plurality of finger sheaths configured to cover the fingers and having tips;
at least one of the finger sheaths having an electrically conducting material disposed at least at the tip of the finger sheath.

2. A glove as claimed in claim 1 and wherein finger sheaths have an outer layer and wherein the electrically conducting material is disposed beneath the outer layer.

3. A glove as claimed in claim 1 and wherein the electrically conducting material comprises a metal disc.

4. A glove as claimed in claim 2 and wherein the metal disc comprises brass.

5. A glove as claimed in claim 1 and wherein the electrically conducting material comprises conductive carbon.

6. A glove as claimed in claim 1 and wherein the electrically conducting material comprises graphite.

7. A glove as claimed in claim 1 and wherein the electrically conducting material comprises metal wire.

8. A glove as claimed in claim 7 and wherein the metal wire is woven into the material of the finger sheath.

9. A glove as claimed in claim 1 and wherein the electrically conducting material comprises nano-coated silver fibers.

10. A glove as claimed in claim 9 and wherein the nano-coated silver fibers are woven into the material of the finger sheath.

11. A glove as claimed in claim 1 and wherein the electrically conducting material comprises aluminized Mylar.

12. A glove as claimed in claim 1 and wherein the electrically conducting material comprises a carbon impregnated semiconductor.

13. A glove capable of activating a capacitive touch screen, said glove comprising a body configured to cover the palm and back of the hand and a plurality of finger sheaths having tips and being configured to cover the fingers and thumb of the hand, and an electrically conductive material disposed at least at the tip of at least of one of said finger sheaths for activating a capacitive touch screen when said tip of said finger sheath is brought toward engagement with the capacitive touch screen.

14. The glove of claim 13 and wherein the finger sheath has an outer layer and wherein the electrically conductive material is disposed beneath the outer layer.

15. The glove of claim 14 and wherein the finger sheath has an inner layer beneath the outer layer and wherein the electrically conductive material is disposed within the inner layer.

16. The glove of claim 15 and wherein the electrically conductive material is configured as a fiber and is woven into the inner layer.

17. The glove of claim 13 and wherein the electrically conductive material is woven into the material of the finger sheath.

18. A method of activating a capacitive touch screen with a gloved hand wherein the glove has finger sheaths having tips that cover the fingers of the hand, the method comprising the steps of disposing an electrically conductive material at least at the tip of at least one of the finger sheaths and moving the tip toward engagement with a capacitive touch screen.

19. The method of claim 18 and where the disposing step comprising weaving an electrically conductive fiber into the material of the finger sheath.

20. The method of claim 18 and wherein the finger sheaths have an outer layer and wherein the disposing step comprises disposing the electrically conductive material beneath the outer layer.

21. A glove for use with a capacitive touch screen comprising a glove body and a plurality of finger sheaths, at least one of said finger sheaths carrying an electrically conductive material at a location where said finger sheath is to be used to engage a capacitive touch screen.

22. A device for interacting with a capacitive touch screen, the device comprising:
a body;
a tip portion for engaging a capacitive touch screen, the tip portion being normally non-conducting; and
an electrically conducting material disposed at least at the tip portion of the device.

23. The device of claim 22 and wherein the device is the cap of a pen or pencil.

24. The device of claim 22 and wherein the electrically conducting material is disposed beneath the surface of the tip portion.
